(19) United States
(12) Patent Application Publication
(10) Pub. No.: US 2025/0073604 A1
(43) Pub. Date: Mar. 6, 2025

(54) Wheelchair Swing System

(71) Applicant: PRx Performance, LLC, Fargo, ND (US)

(72) Inventors: Garrett A. Iverson, Fargo, ND (US); Johnathan A. Erdmann, Fargo, ND (US)

(21) Appl. No.: 18/461,993

(22) Filed: Sep. 6, 2023

(51) Int. Cl. A63G 9/02; A61G 7/10

(52) U.S. Cl. CPC A63G 9/02; A61G 7/1001; A61G 7/1059

(57) ABSTRACT

A wheelchair swing that enables a wheelchair to swing above a support surface includes a frame assembly configured to extend upwardly from the support surface, and a platform assembly operatively coupled to the frame assembly. The platform assembly includes a deck configured to support a wheelchair, and a plurality of swing supports operatively coupled between the deck and the frame assembly and configured to suspend the deck from the frame assembly to enable the deck to swing above the support surface. A deck stabilizer may be operatively coupled to the deck and moveable between a stable operating position wherein the deck stabilizer is engaged with the support surface to substantially prevent the deck from swinging above the support surface, and a swing operating position wherein the deck stabilizer is disengaged from the support surface to enable the deck to swing above the support surface.

### CROSS REFERENCE TO RELATED APPLICATIONS

Not applicable to this application.

### FIELD OF THE INVENTION

The present disclosure relates generally to wheelchair swings, and more specifically, to wheelchair swings having improved platform aspects.

### STATEMENT REGARDING FEDERALLY SPONSORED RESEARCH OR DEVELOPMENT

Not applicable to this application.

### BACKGROUND

Wheelchair swings that enable a person in a wheelchair to enjoy a swinging motion are generally known. Conventional wheelchair swings typically include a platform that supports a wheelchair, and a frame that supports that platform over a support surface (e.g., floor, ground, etc.). The platform is operatively coupled to the frame to enable the platform to swing in a swinging motion. In operation, a user may sit in a wheelchair with the wheelchair positioned on the platform, and may then swing forward and backward with the platform over the support surface. Although desirable results have been achieved using conventional wheelchair swings, there is room for improvement.

### SUMMARY

Some of the various embodiments of the present disclosure relate to wheelchair swings, and more specifically, to wheelchair swings having improved platform aspects.

For example, in some embodiments, a wheelchair swing that enables a wheelchair to swing above a support surface comprises a frame assembly configured to extend upwardly from the support surface, and a platform assembly operatively coupled to the frame assembly. In some embodiments, the platform assembly includes a deck configured to support a wheelchair disposed thereon; a plurality of swing supports operatively coupled between the deck and the frame assembly and configured to suspend the deck from the frame assembly to enable the deck to swing above the support surface; and a deck stabilizer operatively coupled to the deck and moveable between a stable operating position wherein the deck stabilizer is engaged with the support surface to substantially prevent the deck from swinging above the support surface, and a swing operating position wherein the deck stabilizer is disengaged from the support surface to enable the deck to swing above the support surface.

In addition, in some embodiments, a wheelchair swing that enables a wheelchair to swing above a support surface comprises a frame assembly including a plurality of legs that extend upwardly from the support surface, and an upper structure coupled to and supported by the plurality of legs above the support surface, and a platform assembly operatively coupled to the frame assembly. In some embodiments, the platform assembly includes a deck configured to support a wheelchair disposed thereon; a plurality of swing supports operatively coupled between the deck and the upper structure of the frame assembly and configured to suspend the deck from the frame assembly to enable the deck to swing above the support surface; and a plurality of ratchet connectors, each ratchet connector having a first end coupled to the deck and a second end that is engageable with the wheelchair to securely position the wheelchair on the deck.

And in some embodiments, a wheelchair swing that enables a wheelchair to swing above a support surface comprises a frame assembly including a plurality of legs that extend upwardly from the support surface, and an upper structure coupled to and supported by the plurality of legs above the support surface, and a platform assembly operatively coupled to the frame assembly. In some embodiments, the platform assembly includes a deck configured to support a wheelchair disposed thereon; a plurality of swing supports operatively coupled between the deck and the upper structure of the frame assembly and configured to suspend the deck from the frame assembly to enable the deck to swing above the support surface; a ramp operatively coupled to the deck and configured to move between a deployed position that enables the wheelchair to roll on the ramp between the support surface and the deck, and a stowed position that prevents the wheelchair from rolling on the ramp between the support surface and the deck; and a deck stabilizer operatively coupled to the deck and moveable between a stable operating position wherein the deck stabilizer is engaged with the support surface to substantially prevent the deck from swinging above the support surface, and a swing operating position wherein the deck stabilizer is disengaged from the support surface to enable the deck to swing above the support surface, the deck stabilizer in the swing operating position also securing the ramp in the stowed position.

There has thus been outlined, rather broadly, some of the embodiments of the present disclosure in order that the detailed description thereof may be better understood, and in order that the present contribution to the art may be better appreciated. There are additional embodiments that will be described hereinafter and that will form the subject matter of the claims appended hereto. In this respect, before explaining at least one embodiment in detail, it is to be understood that the various embodiments are not limited in its application to the details of construction or to the arrangements of the components set forth in the following description or illustrated in the drawings. Also, it is to be understood that the phraseology and terminology employed herein are for the purpose of the description and should not be regarded as limiting.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evidence to the contrary from the description, where elements in different figures use identical reference numbers, the elements are generally either identical or at least similar in function or purpose.

### BRIEF DESCRIPTION OF THE DRAWINGS

FIG. 1 is a perspective view of a wheelchair swing in accordance with an example embodiment.

FIG. 2 is a perspective view of a platform assembly of the wheelchair swing of FIG. 1 in accordance with an example embodiment.

FIG. 3 is a side view of the platform assembly of FIG. 2 in accordance with an example embodiment.

FIG. 4 is a front view of the platform assembly of FIG. 2 in accordance with an example embodiment.

FIG. 5 is a top view of the platform assembly of FIG. 2 in accordance with an example embodiment.

FIG. 6 is a perspective view of the wheelchair swing of FIGS. 1-5 with a user seated in a wheelchair on the platform assembly in accordance with an example embodiment.

FIG. 7 is a perspective view of a wheelchair swing in accordance with another example embodiment.

FIG. 8 is a perspective view of an upper portion of the platform assembly of FIG. 2 in accordance with another example embodiment.

FIG. 9 is an enlarged perspective view of an adjustment member of the platform assembly of FIG. 2 in accordance with another example embodiment.

FIG. 10 is a perspective view of a rear portion of the platform assembly of FIG. 2 with a wheelchair positioned on the deck and a deck stabilizer in a raised operating position in accordance with an example embodiment.

FIG. 11 is a schematic side view of the rear portion of the platform assembly of FIG. 10 with the deck stabilizer in the raised operating position in accordance with an example embodiment.

FIG. 12 is a perspective view of the rear portion of the platform assembly and the wheelchair of FIG. 10 with the deck stabilizer in a lowered operating position in accordance with an example embodiment.

FIG. 13 is a schematic side view of the rear portion of the platform assembly and the wheelchair of FIG. 12 with the deck stabilizer in the lowered operating position in accordance with an example embodiment.

FIG. 14 is a perspective view of the rear portion of the platform assembly and the wheelchair of FIG. 10 with a ramp in a deployed position in accordance with an example embodiment.

FIG. 15 is a schematic side view of the rear portion of the platform assembly of FIG. 14 with the ramp in the deployed position in accordance with an example embodiment.

FIG. 16 is an enlarged perspective view of a rear portion of the platform assembly of FIG. 2 in accordance with an example embodiment.

FIG. 17 is an enlarged perspective view of a ramp lock assembly of the platform assembly of FIG. 16 with the ramp in a stowed position in accordance with an example embodiment.

FIG. 18 is another enlarged perspective view of the ramp lock assembly of the platform assembly of FIG. 16 with the ramp in the stowed position in accordance with an example embodiment.

FIG. 19 is another enlarged perspective view of the ramp lock assembly of the platform assembly of FIG. 16 with the ramp in the deployed position in accordance with an example embodiment.

### DETAILED DESCRIPTION

### A. Overview

Some of the various embodiments of the present disclosure relate to wheelchair swings that enable a person in a wheelchair to enjoy a swinging motion. For example, in some embodiments, a wheelchair swing includes a frame assembly configured to engage a support surface, and a platform assembly suspended from the frame assembly above the support surface. Additional aspects and operational characteristics of wheelchair swings in accordance with the present disclosure are described below with reference to the accompanying drawings.

### B. Frame Assembly

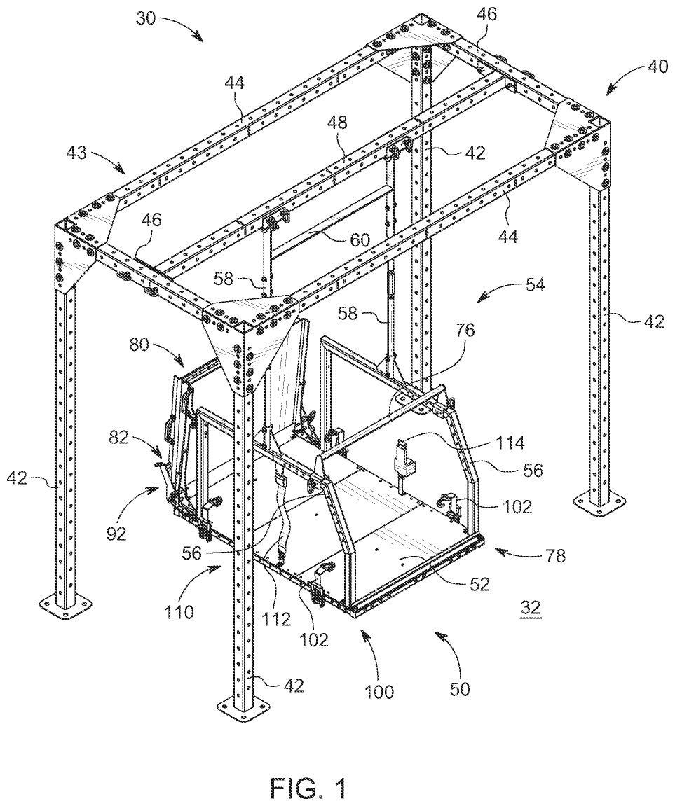

FIG. 1 is a perspective view of a wheelchair swing 30 in accordance with an example embodiment. In some embodiments, the wheelchair swing 30 includes a frame assembly 40 configured to engage a support surface 32, and a platform assembly 50 suspended from the frame assembly 40 above the support surface 32.

The frame assembly 40 may have a variety of suitable configurations. For example, in some embodiments, the frame assembly 40 includes a plurality of legs 42 that engage with and extend upwardly from the support surface 32 to an upper structure 43 disposed above the platform assembly 50. As shown in FIG. 1, in some embodiments, the upper structure 43 includes a pair of side beams 44 coupled to a pair of end beams 46 to form a rectangular structure. In some embodiments, a cross beam 48 extends between the end beams 46, and the platform assembly 50 is operatively coupled to the cross beam 48.

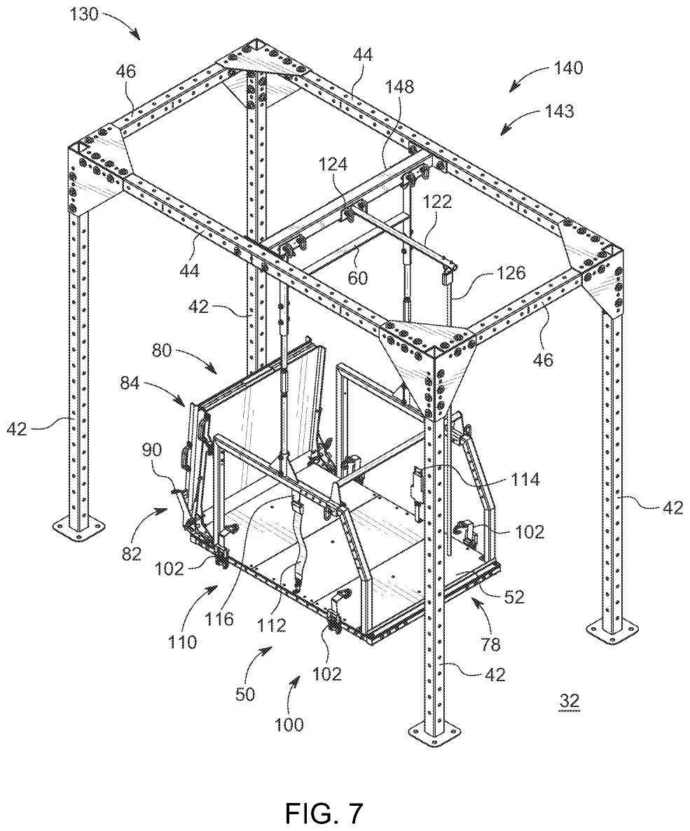

The frame assembly 40 shown in FIG. 1 is merely one possible embodiment that may be used in wheelchair swings in accordance with the present disclosure. For example, FIG. 7 is a perspective view of a wheelchair swing 130 that includes a frame assembly 140 configured to engage the support surface 32 in accordance with another example embodiment. In some embodiments, the frame assembly 140 includes a plurality of legs 42 that engage with and extend upwardly from the support surface 32 to an upper structure 143 disposed above the platform assembly 50. In some embodiments, the upper structure 143 includes the pair of side beams 44 coupled to the pair of end beams 46 to form another rectangular structure, however, a cross beam 148 extends between the side beams 44 (i.e., rather than the end beams 46), with the platform assembly 50 being operatively coupled to the cross beam 148.

It will be appreciated, of course, that the frame assemblies 40, 140 shown in FIGS. 1 and 7 are merely possible embodiments suitable for use with wheelchair swings in accordance with the present disclosure, and that a wide variety of other suitable frame assemblies may be employed.

### C. Platform Assembly

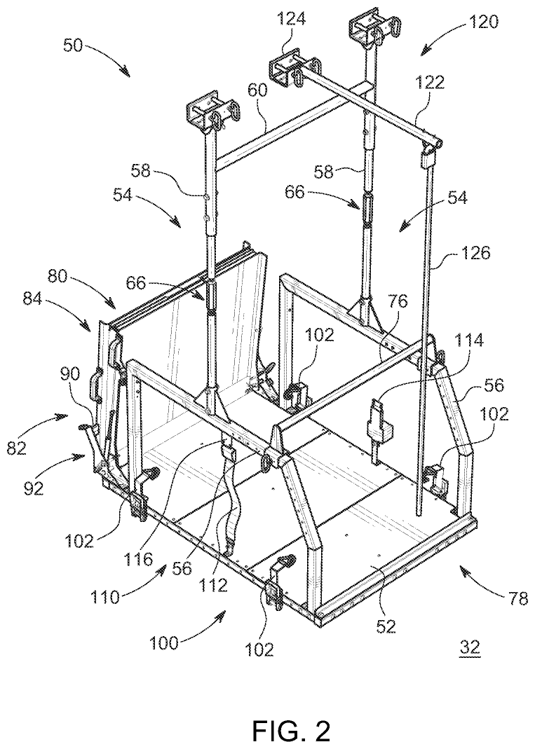

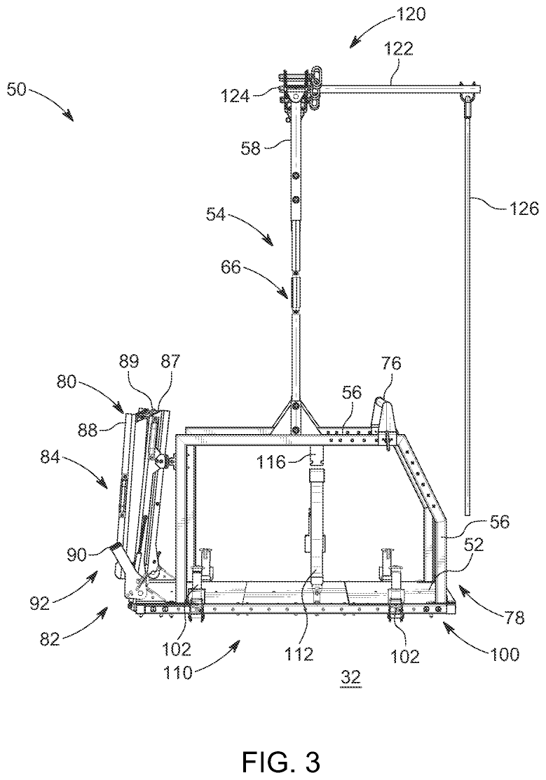

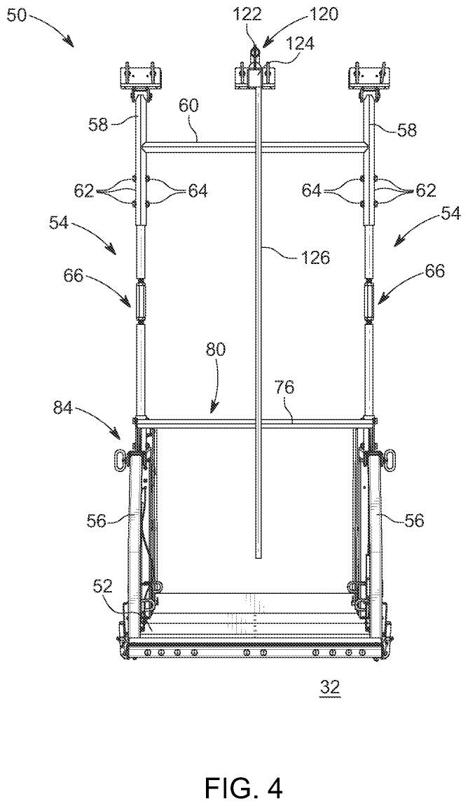

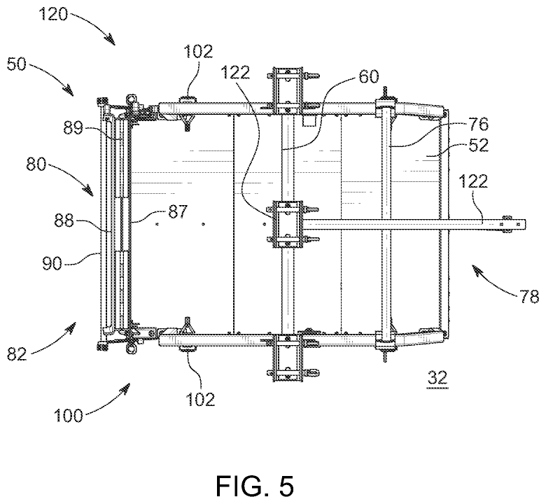

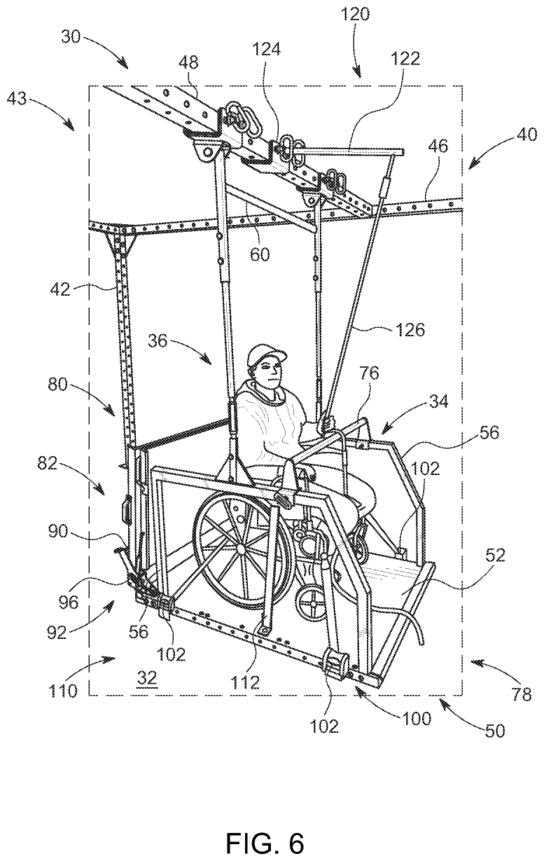

FIG. 2 is a perspective view of the platform assembly 50 of the wheelchair swing of FIG. 1 in accordance with an example embodiment. FIGS. 3-5 are various views of the platform assembly 50 of FIG. 2. FIG. 6 is a perspective view of the wheelchair swing 30 of FIG. 1 with a user 36 seated in a wheelchair 34 on the platform assembly 50. In some embodiments, the platform assembly 50 includes a deck 52 configured to support a wheelchair disposed thereon, and a plurality of swing supports 54 operatively coupled between the deck 52 and the frame assembly 40. The plurality of swing supports 54 may be configured to suspend the deck 52 from the frame assembly 40 to enable the deck 52 to swing back and forth (i.e., forward and backward) above the support surface 32.

For example, in some embodiments, the platform assembly 50 includes a pair of swing supports 54 that are positioned on opposing lateral sides of the deck 52. More specifically, in some embodiments, each swing support 54 includes a side rail 56 operatively coupled to and extending along a lateral side of the deck 52, and a vertical support 58 coupled between the side rail 56 and the frame assembly 40. As best shown in FIGS. 1-3, the side rail 56 of each swing support 54 may be coupled to the deck 52 near the corners thereof, while the vertical support 58 extends upwardly from the side rail 56 to the cross member 48 of the frame assembly 40. In some embodiments, a cross member 60 extends between the vertical supports 58 of the swing supports 54 to provide additional stability.

In addition, in some embodiments, a lower end of the vertical support 58 may be pivotably or rotatably coupled to the side rail 56, while an upper end of the vertical support may be pivotably or rotatably coupled to the frame assembly 40 (e.g., the cross member 48), thereby suspending the platform assembly 50 from the frame assembly 40 and enabling the platform assembly 50 to swing forward and backward over the support surface 32.

In some embodiments, the swing supports 54 may be adjustable to adjust a height h of the deck 52 of the platform assembly 50 above the support surface 32. For example, in some embodiments, the vertical supports 58 of the swing supports 54 may be swapped out or replaced with shorter or longer vertical supports 58.

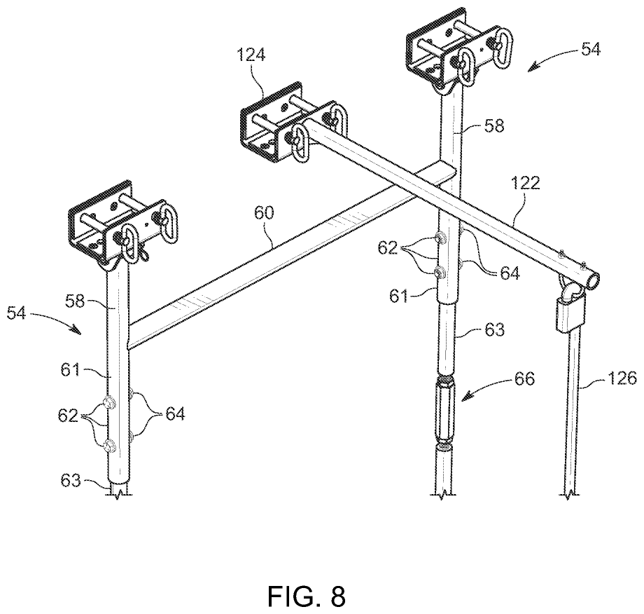

Alternatively, the vertical supports 58 may include one or more mechanisms for adjusting a length of the vertical supports 58. For example, FIG. 8 shows an upper portion of the platform assembly 50 of FIG. 2. In some embodiments, each vertical support 58 includes a first portion 61 coupled to a second portion 63, each of the first and second portions 61, 63 including a series of adjustment holes 62 to enable the first and second portions 61, 63 to be coupled together at a plurality of positions to adjust a height h of the deck 52 above the support surface 32. More specifically, in some embodiments, the adjustment holes 62 (three shown in FIG. 8) are vertically spaced apart along a portion of the vertical support 58, enabling the length of the vertical supports 58 to be adjusted to multiple lengths by sliding the first portion 61 of the vertical support 58 into the second portion 63 of the vertical support 58 (or vice versa), and then inserting one or more adjustment fasteners 64 (two shown) through the adjustment holes 62 to secure the vertical support 58 at a desired length.

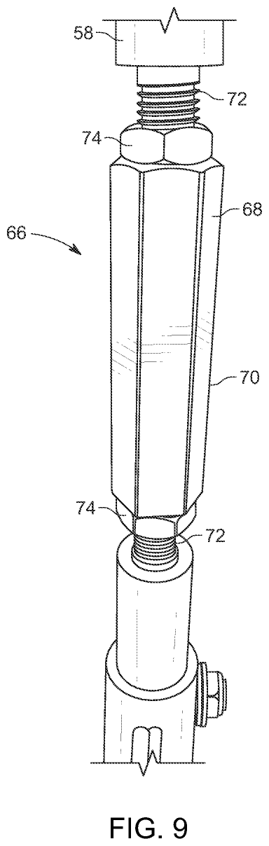

In some embodiments, each vertical support 58 includes an adjustment member 66 that enables adjustment of the height h of the deck 52 of the platform assembly 50 above the support surface 32. For example, FIG. 9 is an enlarged view of the adjustment member 66 of the vertical support 58 of the platform assembly 50 of FIG. 2. In some embodiments, the adjustment member 66 may include a turnbuckle 68 that enables adjustment of the length of the vertical support 58 by simply rotating a center member 70 on threaded portions 72 of the vertical support 58, and then securing a position of the center member 70 onto the threaded portions 72 using one or more positioning nuts 74.

In some embodiments, the platform assembly 50 further includes a front brace 76 that extends between the swing supports 54 proximate to a forward end of the platform assembly 50. More specifically, in some embodiments, the front brace 76 extends between the side rails 56 of the swing supports 54, spanning over the deck 52 near the forward end 78 of the platform assembly 50. As a user in a wheelchair moves into position on the deck 52 of the platform assembly 50, the front brace 76 may serve as a stop mechanism to prevent the wheelchair from exiting from the deck 52 at the front end 78 of the platform assembly 50, and to properly maintain the wheelchair at a desired location on the deck 52. In some embodiments, the front brace 76 is adjustable and moveable to various positions on the swing supports 54 to accommodate different wheelchair sizes.

### D. Ramp

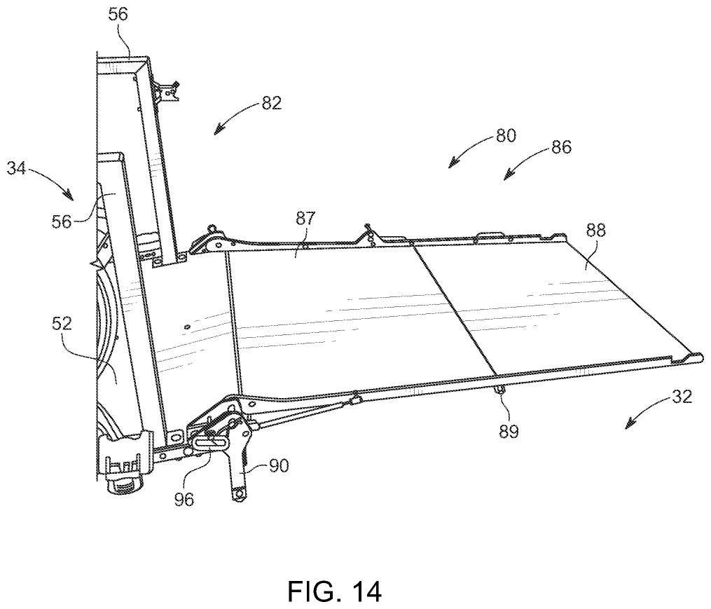

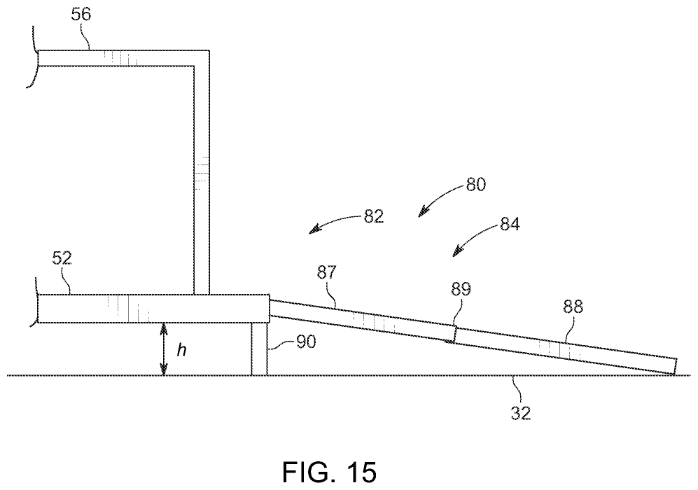

As further shown in FIGS. 1-7, in some embodiments, the platform assembly 50 further includes a ramp 80 operatively coupled to the deck 52 proximate an aft end 82 of the platform assembly 50. In some embodiments, the ramp 80 may be configured to move between a stowed position 84 (see FIGS. 1-4) that prevents a wheelchair from exiting from the aft end 82 of the deck, and a deployed position 86 that enables the wheelchair to roll between the support surface 32 and the deck 52 of the platform assembly 50 (see FIGS. 14-15).

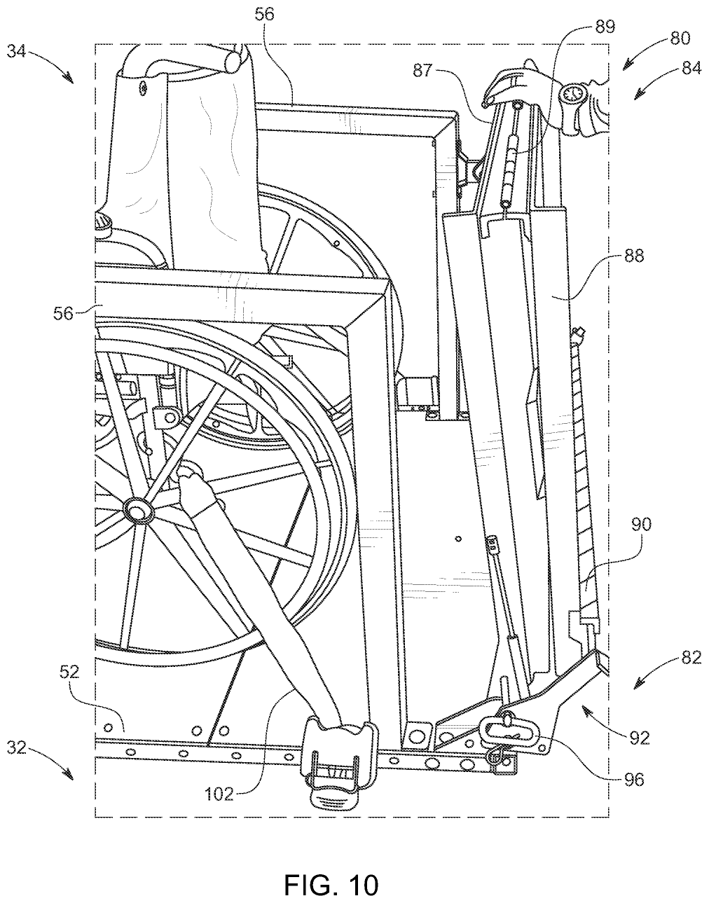

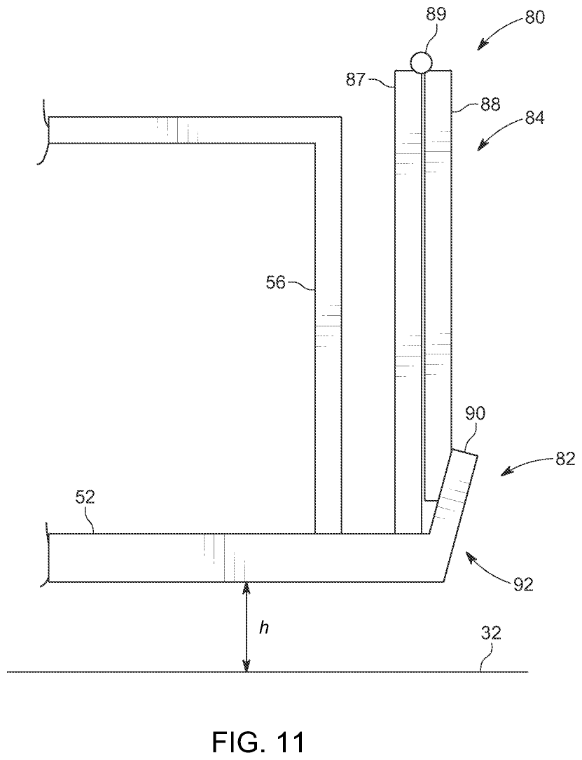

FIGS. 10-11 are perspective and side schematic views of a rear portion of the platform assembly 50 of FIG. 2, and with a wheelchair 34 positioned at a desired location on the deck 52 of the platform assembly 50. In some embodiments, the ramp 80 includes a first ramp portion 87 pivotably coupled to the deck 52 proximate to the aft end 82 of the platform assembly 50, and a second ramp portion 88 pivotably coupled to the first ramp portion 87 by a ramp hinge 89. As best shown in FIG. 11, in the stowed position 84, the first and second ramp portions 87, 88 may be foldable into a roughly vertical position to block the wheelchair from exiting from the deck 52 at the aft end 82 of the platform assembly 50.

It will be appreciated that in some embodiments, the ramp 80 may be eliminated from the platform assembly 50, and an entirely separate ramp or other suitable means may be used to load and unload the wheelchair 34 onto and off of the deck 52 of the platform assembly 50.

### E. Deck Stabilizer

In some embodiments, the platform assembly 50 further includes a deck stabilizer 90 pivotably coupled to the aft end 82 of the deck 52. The deck stabilizer 90 may be movable between a swing operating position 92 and a stable operating position 94. More specifically, as shown in FIGS. 10-11, in the swing operating position 92, the deck stabilizer 90 is disengaged from the support surface 32 to enable the deck 52 to swing above the support surface 32. The deck stabilizer 90 may be secured in position, such as with a securing pin or other suitable mechanism (e.g., detent mechanism, etc.) that is manually removable to enable the deck stabilizer 90 to be adjusted between the swing operating position 92 and the stable operating position 94. In addition, in some embodiments, with the deck stabilizer 90 in the swing operating position 92, the deck stabilizer 90 may capture the second ramp portion 88, to securely maintain the ramp 80 in the stowed position 84, substantially preventing the ramp 80 from moving into the deployed position 86.

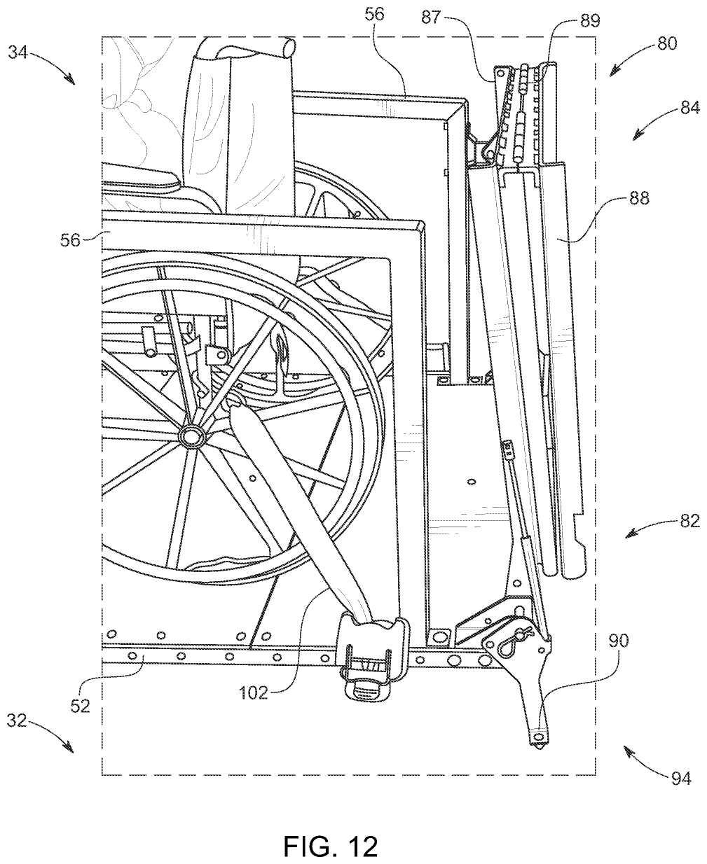

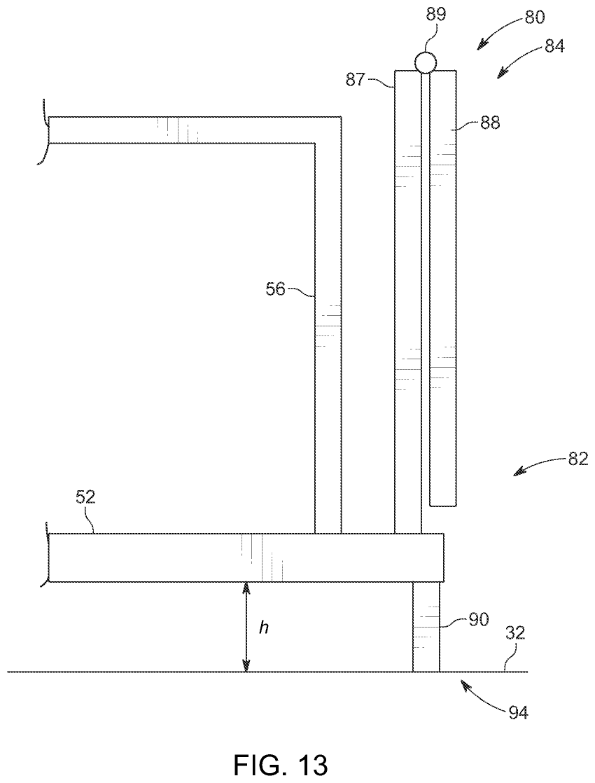

FIGS. 12-13 are perspective and side schematic views of the rear portion of the platform assembly 50 of FIG. 2 with the deck stabilizer 90 moved into the stable operating position 94. In some embodiments, the deck stabilizer 90 may be pivoted downwardly with respect to the deck 52 into the stable operating position 94. In the stable operating position 94, the deck stabilizer 90 is engaged with the support surface 32 to support the deck 52 during loading and unloading operations, maintaining the deck 52 at the height h above the support surface 32, and substantially preventing the deck 52 and the platform assembly 50 from swinging over the support surface 32.

In addition, with the deck stabilizer 90 moved into the stable operating position 94, the ramp 80 may be moved from the stowed position 84 into the deployed position 86. For example, FIGS. 14-15 are perspective and side schematic views of the rear portion of the platform assembly 50 of FIG. 2 with the deck stabilizer 90 moved into the stable operating position 94, and the ramp 80 moved into the deployed position 86. More specifically, in some embodiments, the first ramp portion 87 is pivoted downwardly with respect to the deck 52, and the second ramp portion 88 is pivoted on the ramp hinge 89 with respect to the first ramp portion 87, substantially aligning the first and second ramp portions 87, 88 into an approximately co-planar orientation so that the ramp 80 extends downwardly from the deck to the support surface 32, as shown in FIG. 15.

Accordingly, in some embodiments, a wheelchair swing 30, 130 that enables a wheelchair 34 to swing above a support surface 32, comprises: a frame assembly 40, 140 configured to extend upwardly from the support surface 32; and a platform assembly 50 operatively coupled to the frame assembly 40, 140 and including: a deck 52 configured to support a wheelchair 34 disposed thereon; a plurality of swing supports 54 operatively coupled between the deck 52 and the frame assembly 40, 140 and configured to suspend the deck 52 from the frame assembly 40, 140 to enable the deck 52 to swing above the support surface 32; and a deck stabilizer 90 operatively coupled to the deck 52 and moveable between a stable operating position 94 wherein the deck stabilizer 90 is engaged with the support surface 32 to substantially prevent the deck 52 from swinging above the support surface 32, and a swing operating position 92 wherein the deck stabilizer 90 is disengaged from the support surface 32 to enable the deck 52 to swing above the support surface 32.

In some embodiments, the platform assembly 50 of the wheelchair swing 30, 130 further includes a ramp 80 operatively coupled to the deck 52 and configured to move between a deployed position 86 that enables the wheelchair 34 to roll on the ramp 80 between the support surface 32 and the deck 52, and a stowed position 84 that prevents the wheelchair 34 from rolling on the ramp 80 between the support surface 32 and the deck 52. And in some embodiments, the frame assembly 40, 140 of the wheelchair swing 30, 130 includes a plurality of legs 42 that engage with and extend upwardly from the support surface 32 to an upper structure 43, 143 disposed above the deck 52 of the platform assembly 50, the plurality of swing supports 54 being operatively coupled to the upper structure 43, 143. In some embodiments, the upper structure 43, 143 includes a pair of side beams 44 coupled to a pair of end beams 46 to form a rectangular structure, and a cross beam 48 extending between the end beams 46, the plurality of swing supports 54 being operatively coupled to the cross beam 48.

In addition, in some embodiments, the plurality of swing supports 54 includes a pair of swing supports 54, each swing support 54 including a side rail 56 operatively coupled to and extending along a lateral side of the deck 52, and a vertical support 58 coupled between the side rail 56 and the frame assembly 40, 140. In some embodiments, each vertical support 58 includes a first portion 61 coupled to a second portion 63, each of the first and second portions 61, 63 including a series of adjustment holes 62 to enable the first and second portions 61, 63 to be coupled together at a plurality of positions to adjust a height h of the deck 52 above the support surface 32. And in some embodiments, each swing support 54 includes a turnbuckle 68 that enables adjustment of a height h of the deck 52 above the support surface 32.

### F. Securing System

In some embodiments, the platform assembly 50 of the wheelchair swing 30 further includes a securing system 100 for securing the wheelchair 34 in a desired location on the deck 52 during operation of the wheelchair swing 30. For example, as shown in FIGS. 1-3, 6, and 10, in some embodiments, the securing system 100 includes a plurality of ratchet connectors 102 that may be distributed about and attached to peripheral areas of the deck 52. In the embodiment shown in FIGS. 1-3, 6, and 10, the securing system 100 includes four ratchet connectors 102, however, it will be appreciated that a greater or fewer number of ratchet connectors 102 may be employed. As best shown in FIGS. 6 and 10, in some embodiments, with the wheelchair 34 positioned in a desired location on the deck 52 of the platform assembly 50, the ratchet connectors 102 may be coupled to the wheelchair 34 and tightened to securely position the wheelchair 34 on the deck 52 of the platform assembly 50. For example, in the embodiment having four ratchet connectors 102 shown in FIGS. 1-3, 6, and 10, the two ratchet connectors 102 proximate to the forward end 78 of the platform assembly 50 may be coupled to forward portions of the wheelchair 34, and the two ratchet connectors 102 proximate to the aft end 82 of the platform assembly 50 may be coupled to aft portions of the wheelchair 34, providing four securing forces that securely position the wheelchair 34 in the desired position on the deck 52 of the platform assembly 50.

Accordingly, in some embodiments, the platform assembly 50 of the wheelchair swing 30, 130 further includes a securing system 100 that is engageable with the wheelchair 34 to securely position the wheelchair 34 on the deck 52. More specifically, in some embodiments, the platform assembly 50 further includes a plurality of ratchet connectors 102, each ratchet connector 102 having a first end coupled to the deck 52 and a second end that is engageable with the wheelchair 34 to securely position the wheelchair 34 on the deck 52.

Additionally, in some embodiments, a wheelchair swing 30, 130 that enables a 7 wheelchair 34 to swing above a support surface 32, comprises: a frame assembly 40, 140 configured to extend upwardly from the support surface 32; and a platform assembly 50 operatively coupled to the frame assembly 40, 140 and including: a deck 52 configured to support a wheelchair 34 disposed thereon; a plurality of swing supports 54 operatively coupled between the deck 52 and the frame assembly 40, 140 and configured to suspend the deck 52 from the frame assembly 40, 140 to enable the deck 52 to swing above the support surface 32; and a plurality of ratchet connectors 102, each ratchet connector 102 having a first end coupled to the deck 52 and a second end that is engageable with the wheelchair 34 to securely position the wheelchair 34 on the deck 52.

In further embodiments, the platform assembly 50 includes a deck stabilizer 90 operatively coupled to the deck 52 and moveable between a stable operating position 94 wherein the deck stabilizer 90 is engaged with the support surface 32 to substantially prevent the deck 52 from swinging above the support surface 32, and a swing operating position 92 wherein the deck stabilizer 90 is disengaged from the support surface 32 to enable the deck 52 to swing above the support surface 32. In some embodiments, the platform assembly 50 further includes a ramp 80 operatively coupled to the deck 52 and configured to move between a deployed position 86 that enables the wheelchair 34 to roll on the ramp 80 between the support surface 32 and the deck 52, and a stowed position 84 that prevents the wheelchair 34 from rolling on the ramp 80 between the support surface 32 and the deck 52.

### G. Seatbelt Retainer

In some embodiments, the platform assembly 50 of the wheelchair swing 30 further includes a seatbelt retainer 110 to provide additional support for the person 36 in the wheelchair 34 during operation of the wheelchair swing 30. For example, as shown in FIGS. 1-7, in some embodiments, the seatbelt retainer 110 includes a belt portion 112 that is coupled to the deck 52 at a peripheral edge on one side of the wheelchair 34, and a hasp portion 114 that is coupled to the deck 52 at a peripheral edge on another side of the wheelchair 34 (across from the belt portion 112).

In some embodiments, the belt portion 112 may be an elongated strap member that extends across a lap of the person 36 in the wheelchair 34 and is removably coupled to the hasp portion 114 on the opposite side of the wheelchair 34, thereby helping to secure the person 36 in position in the wheelchair 34 during operation of the wheelchair swing 30. It will be appreciated that one or both of the belt portion 112 and the hasp portion 114 may be partially retractable so that the person 36 may extend the belt portion 112 (and/or the hasp portion 114) in the manner of a conventional seatbelt to extend over a lap of the person 36 in the wheelchair 34. In some embodiments, a belt retainer 116 may be positioned at a convenient location on one of the swing supports 54 (e.g., directly above the belt portion 112) to retain an end of the belt portion 112 when not in use. The belt retainer 116 may advantageously allow the person 36 in the wheelchair 34 to easily reach the belt portion 112 when the wheelchair 34 is positioned in a desired operating position on the deck 52 of the platform assembly 50.

Accordingly, in some embodiments, the platform assembly 50 of the wheelchair swing 30, 130 further includes a seatbelt retainer 110 having a belt portion 112 coupled to the deck 52 and positioned on a first lateral side of the deck 52, and a hasp portion 114 coupled to the deck 52 and positioned on a second lateral side of the deck 52 opposite from the first lateral side, the belt portion 112 being removably couplable to the hasp portion 114 to at least partially secure a person 36 in a seated position within the wheelchair 34 when the wheelchair 34 is positioned on the deck 52.

### H. Rope Assembly

In some embodiments, the wheelchair swing 30 further includes a rope assembly 120 coupled to the frame assembly 40 to enable the person 36 in the wheelchair 34 to provide a swinging force to cause the platform assembly 50 to swing. For example, as shown in FIGS. 2-7, in some embodiments, the rope assembly 120 includes a rope beam 122 that is coupled to the upper structure 43 of the frame assembly 40 by a rope bracket 124. A rope 126 (or other suitable elongated member) hangs downwardly from the rope beam 122 proximate the forward end 78 of the platform assembly 50, within reach of the person 36 seated in the wheelchair 34 positioned on the deck 52 of the platform assembly 50.

In some embodiments, the rope bracket 124 may be coupled to the cross beam 48 of the frame assembly 40. In some embodiments, however, the rope bracket 124 can be attached in various locations on the frame assembly 40 (e.g., end beam 46, side beam 44, leg 42) to enable the person 36 in the wheelchair 34 to pull themselves in a swinging manner.

As best shown in FIG. 6, with the wheelchair 34 positioned and secured in a 16 desirable operating position on the deck 52 of the platform assembly 50, the person 36 may apply a swinging force by pulling on the rope 126 of the rope assembly 120 to move the platform assembly 50 forward with respect to the frame assembly 40 against the force of gravity. When the person 36 releases the swinging force on the rope 126, the platform assembly 50 swings in the aft direction under the influence of gravity, causing the platform assembly 50 to swing back and forth with respect to the frame assembly 40.

Although the rope assembly 120 is described as being equipped with a rope 126, in some embodiments, the rope 126 may be replaced with other suitable structures. For example, in some embodiments, the rope 126 may be suitably replaced with a chain, a cord, a cable, a pole, or any other suitable elongated member.

Accordingly, in some embodiments, the wheelchair swing 30, 130 further includes a rope assembly 120 having a rope beam 122 operatively coupled to the frame assembly 40, 140, and a rope 126 coupled to the rope beam 122 and extending downwardly to a desired operating position of the wheelchair 34 positioned on the deck 52.

### I. Position Control Assembly

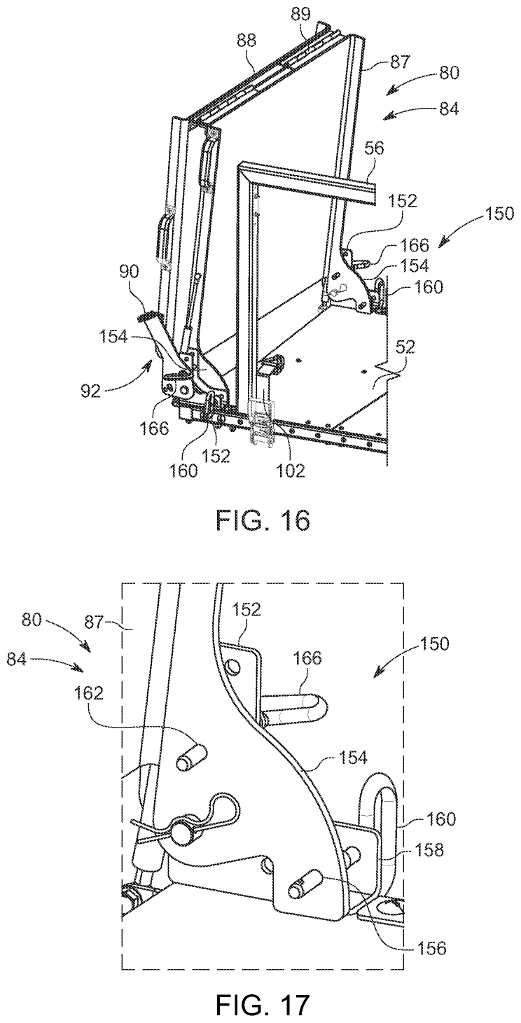

FIG. 16 is an enlarged perspective view of a rear portion of the platform assembly 50 of FIG. 2 in accordance with an example embodiment. As described above, in some embodiments, the platform assembly 50 includes the ramp 80 pivotably coupled to the deck 52 of the platform assembly 50 and moveable between the stowed position 84 and the deployed position 86. And in some embodiments, the platform assembly 50 includes the deck stabilizer 90 pivotably coupled to the deck 52 of the platform assembly 50 and moveable between the swing operating position 92 and the stable operating position 94. In FIG. 16, the ramp 80 is positioned in the stowed position 84 and the deck stabilizer 90 is positioned in the swing operating position 92.

In some embodiments, the platform assembly 50 further includes one or more position control assemblies 150. For example, as shown in FIG. 16, in some embodiments, the platform assembly 50 includes a pair of position control assemblies 150, each position control assembly 150 being located at a corner of the deck 52 at the rearward end of the deck 52 proximate to the ramp 80, operatively coupling the ramp 80 to the deck 52 of the platform assembly 50.

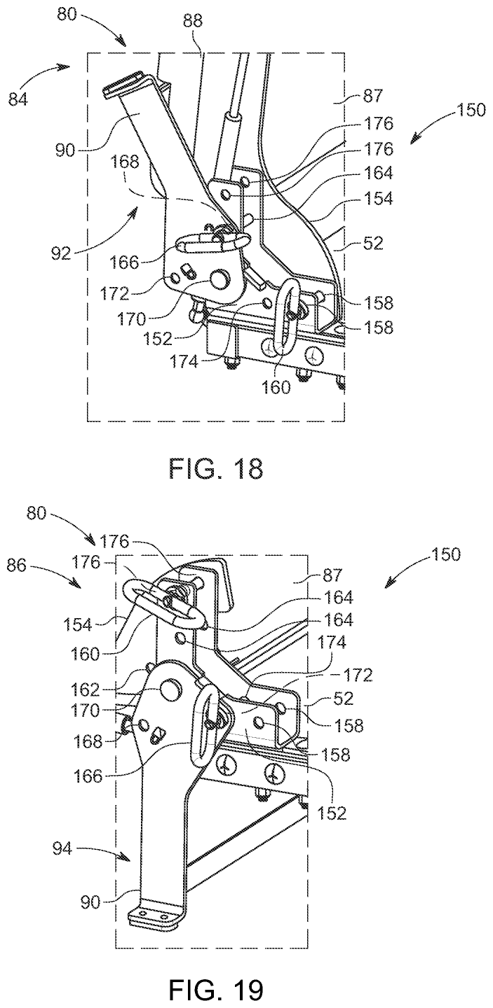

FIG. 17 is an enlarged perspective view of one of the ramp lock assemblies 150 of the platform assembly 50 of FIG. 16 in accordance with an example embodiment. FIG. 18 is an enlarged perspective view of another ramp lock assembly 150 of the platform assembly 50 of FIG. 16 with the ramp 80 in the stowed position 92. And FIG. 19 is an enlarged perspective view of the ramp lock assembly 150 of FIG. 18 with the ramp 80 in the deployed position 86. As shown in FIGS. 16-19, in some embodiments, the position control assembly 150 includes a locking bracket 152 that is coupled to the deck 52, and a positioning flange 154 that is coupled to the first ramp portion 87 of the ramp 80. The positioning flange 154 is positioned proximate to the locking bracket 152 and is moveable with respect to the locking bracket 152 as the ramp 80 is moved between the stowed position 84 (FIGS. 16-18) and the deployed position 86 (FIG. 19).

More specifically, in some embodiments, with the ramp 80 in the stowed position 84 (FIGS. 16-18), a first flange hole 156 in the positioning flange 154 is aligned with one or more first bracket holes 158 in the locking bracket 152. A first locking pin 160 is inserted through the first bracket hole(s) 158 of the locking bracket 152, and through the first flange hole 156 of the positioning flange 154, thereby securing the ramp 80 in the stowed position 84.

Similarly, with the ramp 80 in the stowed position 84 (FIGS. 16-18), a second flange hole 162 in the positioning flange 154 is aligned with one or more second bracket holes 164 in the locking bracket 152. Accordingly, a second locking pin 166 is inserted through the second bracket hole(s) 164 of the locking bracket 152, and through the second flange hole 162 of the positioning flange 154, further securing the ramp 80 in the stowed position 84.

As further shown in FIGS. 16-18, in some embodiments, with the ramp 80 in the stowed position 84 and the deck stabilizer 90 in the swing operating position 92, a first stabilizer hole 168 disposed in the deck stabilizer 90 is aligned with the second bracket holes 164 of the locking bracket 152, and with the second flange hole 162 of the positioning flange 154. Therefore, the second locking pin 166 may also be inserted through the first stabilizer hole 168 in the deck stabilizer 90, and the second bracket hole(s) 164 of the locking bracket 152, thereby securing the deck stabilizer 90 in the swing operating position 92.

In some embodiments, to move the deck stabilizer 90 from the swing operating position 92 (FIGS. 16-18) to the stable operating position 94 (FIG. 19), the second locking pin 166 is withdrawn from the second flange hole 162, the one or more second bracket holes 164, and the first stabilizer hole 168. The deck stabilizer 90 may then be rotated downwardly about a stabilizer pivot 170 from the swing operating position 92 (FIGS. 16-18) into the stable operating position 94 (FIG. 19), at which a second stabilizer hole 172 in the deck stabilizer 90 is aligned with one or more third bracket holes 174 in the locking bracket 152. The second locking pin 166 may then be inserted through the second stabilizer hole 172 in the deck stabilizer 90, and the third bracket hole(s) 174 in the locking bracket 152, securing the deck stabilizer 90 in the stable operating position 94 (FIG. 19).

Similarly, to move the ramp 80 from the stowed position 84 (FIGS. 16-18) to the deployed position 86 (FIG. 19), the first locking pin 160 is withdrawn from the first flange hole 156, and the one or more first bracket holes 158. The first ramp portion 87 of the ramp 80 may then be rotated downwardly from the stowed position 84 (FIGS. 16-18) into the deployed position 86 (FIG. 19), causing the positioning flange 154 to rotate with respect to the locking bracket 152. With the ramp 80 in the deployed position 86, the first flange hole 156 is aligned with one or more fourth bracket holes 176 in the locking bracket 152. The first locking pin 160 may then be inserted through the fourth bracket hole(s) 176 in the locking bracket 152, and the first flange hole 156 in the positioning flange 154, securing the ramp in the deployed position 86 (FIG. 19).

### J. Operation of Preferred Embodiment

In operation, in some embodiments, the deck stabilizer 90 of the platform assembly 50 is positioned in the stable operating position 94 (FIGS. 12-15), and the ramp 80 is positioned in the deployed position 86 (FIGS. 14-15). The wheelchair 34 (and the person 36 seated in the wheelchair 34) may then be rolled from the support surface 32 up the ramp 80 and onto the deck 52 of the platform assembly 50. The wheelchair 34 may then be moved forward on the deck 52 until it reaches the front brace 76 and is positioned in the desired operating position on the deck 52.

In some embodiments, with the wheelchair 34 on the deck 52 of the platform assembly 50 in the desired operating position, the ratchet connectors 102 of the securing system 100 may be engaged with the wheelchair 34, applying a securing force on the wheelchair 34 to secure the wheelchair 34 in the desired operating position. In addition, in some embodiments, the belt portion 112 of the seatbelt retainer 110 is engaged across the lap of the person 36 and securely engaged with the hasp portion 114, helping to secure the person 36 in place in the wheelchair 34. Of course, in some embodiments, the wheelchair may have its own on-board system of one or more belts or harnesses that secure the person 36 within the wheelchair 34.

With the wheelchair 34 in place on the deck 52 of the platform assembly 50, the ramp 80 may be moved into the stowed position 84 (FIGS. 1-11), and the deck stabilizer 90 may be moved to and securely positioned in the swing operating position 92, enabling the platform assembly 50 to move freely with respect to the support surface 32. With the swing assembly 30 configured for safe operations, the person 36 in the wheelchair 34 may then apply a swinging force by pulling on the rope 126 of the rope assembly 120 to move the platform assembly 50 forward with respect to the frame assembly 40 against the force of gravity. When the person 36 releases the swinging force on the rope 126, the platform assembly 50 swings in the aft direction under the influence of gravity, causing the platform assembly 50 to swing back and forth with respect to the frame assembly 40. The person 36 may continue to periodically apply the swinging force on the rope 126 to cause the platform assembly 50 to continue swinging back and forth as desired.

When the person 36 has finished swinging, in some embodiments, the platform assembly 50 may be brought to a standstill with respect to the support surface 32, and the deck stabilizer 90 is then moved into the stable operating position 94, securing the deck stabilizer 90 into engagement with the support surface 32. The ramp 80 may then be moved into the deployed position 86, and the seatbelt retainer 110 and the securing system 100 may be disengaged, permitting the wheelchair 34 to be moved as desired. The wheelchair 34 may then be moved toward the aft end 82 of the deck 52 and down the ramp 80 to the support surface 32.

Accordingly, in some embodiments, a wheelchair swing 30, 130 that enables a wheelchair 34 to swing above a support surface 32, comprises: a frame assembly 40, 140 including a plurality of legs 42 that extend upwardly from the support surface 32, and an upper structure 43, 143 coupled to and supported by the plurality of legs 42 above the support surface 32; and a platform assembly 50 operatively coupled to the frame assembly 40, 140 and including: a deck 52 configured to support a wheelchair 34 disposed thereon; a plurality of swing supports 54 operatively coupled between the deck 52 and the frame assembly 40, 140 and configured to suspend the deck 52 from the frame assembly 40, 140 to enable the deck 52 to swing above the support surface 32; a ramp 80 operatively coupled to the deck and configured to move between a deployed position 86 that enables the wheelchair 34 to roll on the ramp 80 between the support surface 32 and the deck 52, and a stowed position 84 that prevents the wheelchair 34 from rolling on the ramp 80 between the support surface 32 and the deck 52; and a deck stabilizer 90 operatively coupled to the deck 52 and moveable between a stable operating position 94 wherein the deck stabilizer 90 is engaged with the support surface 32 to substantially prevent the deck 52 from swinging above the support surface 32, and a swing operating position 92 wherein the deck stabilizer 90 is disengaged from the support surface 32 to enable the deck 52 to swing above the support surface 32, the deck stabilizer 90 in the swing operating position 92 also securing the ramp 80 in the stowed position 84.

In some embodiments, the platform assembly 50 further includes a plurality of ratchet connectors 102, each ratchet connector 102 having a first end coupled to the deck 52 and a second end that is engageable with the wheelchair 34 to securely position the wheelchair 34 on the deck 52. In some embodiments, the plurality of swing supports 54 includes a pair of swing supports 54, each swing support 54 including a side rail 56 operatively coupled to and extending along a lateral side of the deck 52, and a vertical support 58 coupled between the side rail 56 and the frame assembly 40, 140. And in some embodiments, the platform assembly 50 further includes a seatbelt retainer 110 having a belt portion 112 coupled to the deck 52 and positioned on a first lateral side of the deck 52, and a hasp portion 114 coupled to the deck 52 and positioned on a second lateral side of the deck 52 opposite from the first lateral side, the belt portion 112 being removably couplable to the hasp portion 114 to at least partially secure a person 36 in a seated position within the wheelchair 34 when the wheelchair 34 is positioned on the deck 52.

While various embodiments have been described above, it should be understood that they have been presented by way of example only, and not limitation. The descriptions are not intended to limit the scope of the technology to the particular forms set forth herein. To the contrary, the present descriptions are intended to cover such alternatives, modifications, and equivalents as may be included within the spirit and scope of the technology as defined by the appended claims and otherwise appreciated by one of ordinary skill in the art. The various embodiments of the present disclosure may be embodied in other specific forms without departing from the spirit or essential attributes thereof, and it is therefore desired that the various embodiments in the present disclosure be considered in all respects as illustrative and not restrictive. Thus, the breadth and scope of a preferred embodiment should not be limited by any of the above-described exemplary embodiments.

Unless otherwise defined, all technical and scientific terms used herein have the same meaning as commonly understood by one of ordinary skill in the art to which this invention belongs. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls. Any headings utilized within the description are for convenience only and have no legal or limiting effect.

What is claimed is:

1. A wheelchair swing that enables a wheelchair to swing above a support surface, comprising:
a frame assembly configured to extend upwardly from the support surface; and
a platform assembly operatively coupled to the frame assembly and including:
a deck configured to support a wheelchair disposed thereon;
a plurality of swing supports operatively coupled between the deck and the frame assembly and configured to suspend the deck from the frame assembly to enable the deck to swing above the support surface; and
a deck stabilizer operatively coupled to the deck and moveable between a stable operating position wherein the deck stabilizer is engaged with the support surface to substantially prevent the deck from swinging above the support surface, and a swing operating position wherein the deck stabilizer is disengaged from the support surface to enable the deck to swing above the support surface.

2. The wheelchair swing of claim 1, wherein the platform assembly further includes a ramp operatively coupled to the deck and configured to move between a deployed position that enables the wheelchair to roll on the ramp between the support surface and the deck, and a stowed position that prevents the wheelchair from rolling on the ramp between the support surface and the deck.

3. The wheelchair swing of claim 1, wherein the frame assembly includes a plurality of legs that engage with and extend upwardly from the support surface to an upper structure disposed above the deck of the platform assembly, the plurality of swing supports being operatively coupled to the upper structure.

4. The wheelchair swing of claim 3, wherein the upper structure includes a pair of side beams coupled to a pair of end beams to form a rectangular structure, and a cross beam extending between the end beams, the plurality of swing supports being operatively coupled to the cross beam.

5. The wheelchair swing of claim 1, wherein the plurality of swing supports includes a pair of swing supports, each swing support including a side rail operatively coupled to and extending along a lateral side of the deck, and a vertical support coupled between the side rail and the frame assembly.

6. The wheelchair swing of claim 1, wherein each swing support includes a first portion coupled to a second portion, each of the first and second portions including a series of adjustment holes to enable the first and second portions to be coupled together at a plurality of positions to adjust a height of the deck above the support surface.

7. The wheelchair swing of claim 1, wherein each swing support includes a turnbuckle that enables adjustment of a height of the deck above the support surface.

8. The wheelchair swing of claim 1, wherein the platform assembly further includes a securing system that is engageable with the wheelchair to securely position the wheelchair on the deck.

9. The wheelchair swing of claim 1, wherein the platform assembly further includes a plurality of ratchet connectors, each ratchet connector having a first end coupled to the deck and a second end that is engageable with the wheelchair to securely position the wheelchair on the deck.

10. The wheelchair swing of claim 1, wherein the platform assembly further includes a seatbelt retainer having a belt portion coupled to the deck and positioned on a first lateral side of the deck, and a hasp portion coupled to the deck and positioned on a second lateral side of the deck opposite from the first lateral side, the belt portion being removably couplable to the hasp portion to at least partially secure a person in a seated position within the wheelchair when the wheelchair is positioned on the deck.

11. The wheelchair swing of claim 1, further including a rope assembly having a rope beam operatively coupled to the frame assembly, and a rope coupled to the rope beam and extending downwardly to a desired operating position of the wheelchair positioned on the deck.

12. A wheelchair swing that enables a wheelchair to swing above a support surface, comprising:
a frame assembly including a plurality of legs that extend upwardly from the support surface, and an upper structure coupled to and supported by the plurality of legs above the support surface; and
a platform assembly operatively coupled to the frame assembly and including:
a deck configured to support a wheelchair disposed thereon;
a plurality of swing supports operatively coupled between the deck and the upper structure of the frame assembly and configured to suspend the deck from the frame assembly to enable the deck to swing above the support surface; and
a plurality of ratchet connectors, each ratchet connector having a first end coupled to the deck and a second end that is engageable with the wheelchair to securely position the wheelchair on the deck.

13. The wheelchair swing of claim 12, wherein the platform assembly further includes a deck stabilizer operatively coupled to the deck and moveable between a stable operating position wherein the deck stabilizer is engaged with the support surface to substantially prevent the deck from swinging above the support surface, and a swing operating position wherein the deck stabilizer is disengaged from the support surface to enable the deck to swing above the support surface.

14. The wheelchair swing of claim 12, wherein the platform assembly further includes a ramp operatively coupled to the deck and configured to move between a deployed position that enables the wheelchair to roll on the ramp between the support surface and the deck, and a stowed position that prevents the wheelchair from rolling on the ramp between the support surface and the deck.

15. The wheelchair swing of claim 12, wherein the plurality of swing supports includes a pair of swing supports, each swing support including a side rail operatively coupled to and extending along a lateral side of the deck, and a vertical support coupled between the side rail and the frame assembly.

16. The wheelchair swing of claim 12, wherein each swing support includes an adjustment member that enables adjustment of a height of the deck above the support surface.

17. A wheelchair swing that enables a wheelchair to swing above a support surface, comprising:
a frame assembly including a plurality of legs that extend upwardly from the support surface, and an upper structure coupled to and supported by the plurality of legs above the support surface; and
a platform assembly operatively coupled to the frame assembly and including:
a deck configured to support a wheelchair disposed thereon;
a plurality of swing supports operatively coupled between the deck and the upper structure of the frame assembly and configured to suspend the deck from the frame assembly to enable the deck to swing above the support surface;
a ramp operatively coupled to the deck and configured to move between a deployed position that enables the wheelchair to roll on the ramp between the support surface and the deck, and a stowed position that prevents the wheelchair from rolling on the ramp between the support surface and the deck; and
a deck stabilizer operatively coupled to the deck and moveable between a stable operating position wherein the deck stabilizer is engaged with the support surface to substantially prevent the deck from swinging above the support surface, and a swing operating position wherein the deck stabilizer is disengaged from the support surface to enable the deck to swing above the support surface, the deck stabilizer in the swing operating position also securing the ramp in the stowed position.

18. The wheelchair swing of claim 17, wherein the platform assembly further includes a plurality of ratchet connectors, each ratchet connector having a first end coupled to the deck and a second end that is engageable with the wheelchair to securely position the wheelchair on the deck.

19. The wheelchair swing of claim 17, wherein the ramp is operatively coupled to the deck by at least one position control assembly that includes a locking bracket operatively coupled to the deck and a position flange operatively coupled to the ramp, the position flange being selectively couplable to the locking bracket to enable the ramp to be moved between the deployed position and the stowed position.

20. The wheelchair swing of claim 17, wherein the platform assembly further includes a seatbelt retainer having a belt portion coupled to the deck and positioned on a first lateral side of the deck, and a hasp portion coupled to the deck and positioned on a second lateral side of the deck opposite from the first lateral side, the belt portion being removably couplable to the hasp portion to at least partially secure a person in a seated position within the wheelchair when the wheelchair is positioned on the deck.
